(19) United States
(12) Patent Application Publication
(10) Pub. No.: US 2002/0182376 A1
(43) Pub. Date: Dec. 5, 2002

(54) Novel universal ink jet recording medium

(76) Inventors: Debabrata Mukherjee, Spring Grove, PA (US); Daniel L. Krueger, York, PA (US); Ann L. Rishel, York, PA (US); Leo M. Nelli, Spring Grove, PA (US); Timothy R. Hess, Dallastown, PA (US)

Correspondence Address: Marc J Farrell, Reed Smith LLP, 213 Market Street 9th Floor, P O Box 11844, Harrisburg, PA, 17108-1844, US

(21) Appl. No.: 09/818,095

(22) Filed: Mar. 27, 2001

(51) Int. Cl. B41M 5/00

(52) U.S. Cl. 428/195

(57) ABSTRACT

The described invention is an unique universal ink jet media. The invention incorporates a unique barrier layer based upon UV or EB curable chemistry which replaces common polyethylene extruded bases. The invention also incorporates multiple ink receptive layers. The first layer is based upon gelatin and/or polyvinyl alcohol (PVOH) chemistries and gives the invention excellent ink drytime. Poor drytime is a common problem which leads to smudging and print defects, especially as ink jet printer speeds increase as technology improves. The high ink absorbency of the invention also makes this media well suited for wide format ink jet printers. The next ink receptive layer(s) are based upon pigmented, cellulose chemistry which reduces the tack of the sheet and gives the sheet good waterfastness. This is important for the end use in that the sheet may be frequently handled and exposed to dampness. Another unique property provided by the next ink receptive layer(s) is excellent print quality across a wide range of printers and ink sets (both dye and pigmented), in which other media perform poorly. A final unique property is an anti-curl coating which resists curling as the ambient conditions change from cold and dry to hot and humid.

### BACKGROUND OF THE INVENTION

The field of ink jet printing has exploded in the past decade, with rapid development of ink jet printers which provide higher resolution images in shorter times. Additionally, ink manufactures have addressed problems such as image fade over time by formulating inks based upon colored pigments instead of dyes. The explosion of digital cameras has driven demand for photo-like papers which print well with ink jet printers. However, these technology improvements have presented problems for ink jet media which this invention addresses through unique chemistries.

One common problem with ink jet media is that the new pigmented inks do not adhere well to the ink receptive surface. Even after extended periods of drying, the ink can be readily smudged. This presents an undesirable end use problem, especially for photo images, which are likely to be handled repetitively.

Another common problem is that ink jet media do not work well across a wide range of printer platforms. This requires commercial users to inventory different media for different printers, which increases cost as the user may not be able to buy bulk quantities, and take up more inventory space. Home users are likely to use the same paper across multiple printers and are often dissatisfied when a media works on some printers but not on others.

Additionally, as printers have gotten faster, the inks (whether they be pigmented or dye based) do not dry quickly enough. This can lead to print defects (such as puddling or wicking) as the wet inks mix undesirably, or smudging when the print is handled right out of the printer. This problem is especially common for media designed for wide format (greater than 24″ wide) ink jet printers as these printers tend to lay down more ink than desktop printers.

Since these media (especially for photo-like applications) are likely to be handled repetitively, the media must not be tacky to the touch and be resistant to water (such as from sweat or moisture). A tacky media is more likely to become sticky under high humidity conditions, which can cause sheets to stick together and jam in the ink jet printer. Many ink jet media (especially those for photo-like applications) are tacky to the touch. Additionally, most ink jet media do not have good water resistance, so the printed image is smudged by sweaty fingers or accidental exposure to moisture.

An additional concern is that many ink jet media will curl over time, especially when the temperature and humidity are high (a common problem in many parts of the world, or in common storage areas such as attics).

The present invention addresses these concerns through the application of unique chemistry.

### SUMMARY OF INVENTION

This ink jet recording sheet comprises a substrate sheet of any caliper; a formed undercoat layer on the substrate sheet comprising pigments and binders; a formed hydrophobic glossy barrier layer on top of this undercoat comprised of ultraviolet or electron beam curable polymers or polyethylene; an ink receptive layer on top of the afore mentioned layer (Layer A); and optionally, but preferably, additional ink receptive layer(s) on top of the afore mentioned ink receptive layer (Layer B, C, etc). Additionally, an optional anti-curl layer is applied to the backside of the substrate sheet to resist curl over a wide range of humidities and temperatures.

### BRIEF DESCRIPTION OF THE DRAWINGS

The invention will become more readily apparent from the following description of preferred embodiments thereof shown, by way of example only, in the accompanying drawings wherein:

FIG. 1 is a cross-sectional view of the invention depicting the various layers of substrate and coating.

### DETAILED DESCRIPTION

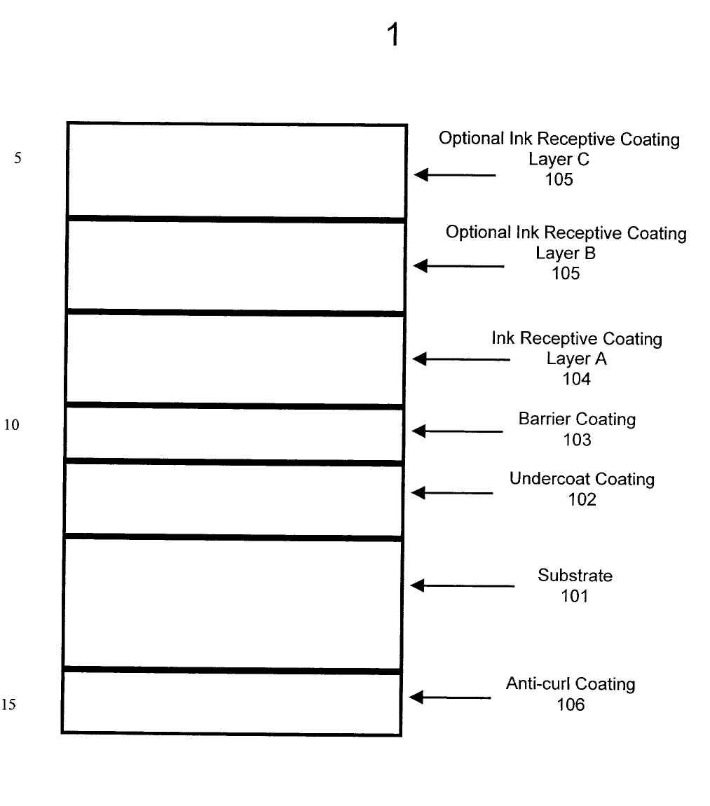

Referring to FIG. 1, a cross-section of the present invention is depicted to show the ordering of the various layers of coatings, some of which are optional. The barrier layer must be under the ink receptive layer(s). The ink receptive layers can change in order, though the order in FIG. 1 is preferred.

In the ink jet recording sheet of the present invention, the substrate 101 consists of a wood fiber base consisting of any blend of hardwood and softwood fibers; starches such as but not limited to oxidized, corn, potato, and cationic; high levels (10-40%, preferably above 25%) of inorganic fillers such as but not limited to clay, calcium carbonate, and aluminas; retention aids and formation aids of any nature; plasticizers such as, but not limited to, polyethylene glycol and glycerine; slip agents such as but not limited to sterates; optical brighteners dyes known to one skilled in the art; hydrophobic additives such as but not limited to Alkenyl Succinic Anhydride (ASA) and Alkyl Ketene Dimer (AKD); and other common paper making additives known to those skilled in the art.

The undercoat layer 102 consists of 5-100 dry percent of natural and synthesized inorganic pigments such as, but not limited to, clay, calcium carbonate, titanium dioxide, aluminas; 1-50 dry percent of latexes, such as, but not limited to, styrene-butadiene, poly-vinyl acetate, acrylics, vinyl -acetate, ethylene-vinyl chloride, urethanes; 1-50 dry percent binders such as, but not limited to, starch, protein, polyvinyl alcohol, and gelatin; flow and slip agents commonly known to one skilled in the art; optical brighteners and dyes commonly known to one skilled in the art; and other common coating additives known to those skilled in the art. This undercoat layer 102 gives a smooth, high brightness, high holdout pre-coat for the barrier layer 103. “Hold out” measures how well a layer prevents the next layer from penetrating into it. Layer 102 only allows for minimal, if any, penetration into barrier layer 103.

If this undercoat 102 does not have sufficient holdout, a barrier layer or barrier coating 103, which is cured by UV or EB chemistry, will penetrate too far into the substrate 101. The holdout was measured by a Gurley Densometer (following TAPPI Method T536). It was found experimentally that the preferred holdout is greater than 10,000 seconds per 100 cc/in². A low reading from the densometer will cause the barrier layer 103 to have poor holdout, which will make it a poor water barrier. The undercoat layer 102 can be coated at a coat weight of 2-40 dry grams per square meter (gsm) on any coater, such as but not limited to blade, rod, gate-roll, slot die, cascade, and gravure. This undercoat layer 102 is optional if the substrate has sufficient hold out for the barrier layer 103.

The barrier layer 103 comprises one or more hydrophobic water barriers and serves two important purposes; specifically to act as a liquid water barrier between the substrate 101 and the ink receptive layers 104 and 105, and to give a smooth, high gloss surface for the top ink receptive layers. Work done by the inventors has shown that a high gloss barrier layer is one of the ways to develop a high gloss finished product.

This water barrier prevents sheet cockle during subsequent coating operations and in the end use. When printing on a media that does not have a barrier layer, especially on a wide format ink jet printer, the inks will penetrate into the substrate. If the substrate is cellulose fiber based, the fibers will swell and cause the sheet surface to become wavy, or cockle. The ink jet printer print head will impact these cockles, thus smearing the printed image or jamming the print head. This problem is commonly known as “print head crashing”.

This barrier layer 103 may comprise either polyethylene (preferably low density) or monomers and oligomers which can be cured via high temperature or ultra-violet or electron beam energies. The barrier layer may comprise 1-100 dry percent monomers, for example but not limited to, monomers in the urethane, epoxy, and acrylate chemical families (referred to as “urethanes, epoxies and acrylates”); 1-100 dry percent oligomers, for example, but not limited to, oligomers in the urethane, epoxy, and acrylate chemical families (referred to as “urethanes, epoxies, and acrylates”); optionally 0.1-25 dry percent photoinitiator, optionally 0.01-20 dry percent optical brightener and dyes; and other flow and slip additives. The barrier layer will have a gloss measured at 60 degrees of 20-100%, preferably 60-100 % to give a good finished gloss. Gloss measures how shiny the paper appearance is.

It is important that the barrier coat have a surface energy of 30-55 dynes, preferably 48-55 dynes, to allow good wettability and adhesion to the ink receptive layer(s) 104-105. Optionally, the barrier layer may be treated with either a corona discharge, flame, or a “subbing” coating which gives good wetability and adhesion for the ink receptive layer. (A subbing coating is a thin film of gelatin that may improve the adhesion of subsequent coating layers to the barrier layer. The barrier layer can be coated at a coat weight of 1-30 dry gsm on any coater such as, but not limited to, extrusion, blade, rod, gate-roll, slot die, cascade, and gravure.

Ink receptive layer A or ink receptive coating 104 is comprised of 10-100 dry percent water loving or hydrophilic polymers, for example but not limited to gelatin, polyvinyl alcohol, polyvinyl pyrroilidone, methylcellulose, hydroxyethylcellulose, and/or propylhydroxycellulose; 0.1-20 dry percent cationic water loving (hydrophilic) and solvent loving (lipophilic) polymers, for example but is not limited to polydadmacs, polyethylene imines, polyamides, and polyamines; 0-30 dry percent latex binders for example but is not limited to styrene-butadiene, polyvinyl acetate, acrylics, vinyl -acetate, ethylene-vinyl chloride, and urethanes; 0.01-20 dry percent crosslinking agents for example, but not limited to, aziradines and chrom alum; and 0-75 dry percent inorganic pigments for example but not limited to colloidal, precipitated, fumed, and gel silicas, clay, aluminas, and calcium carbonates; and optionally optical brighteners, dyes, flow agents, and other coating additives. The ink receptive layer can be coated at a coat weight of 1-50 dry gsm on any coater, such as but not limited to blade, rod, gate-roll, slot die, cascade, and gravure.

Key components of ink receptive layer A 104 are polyvinyl alcohol (PVOH), gelatin, and/or polyvinyl pyrrolidone which absorb the bulk of the water and solvents present in the ink jet inks so that the sheet dries quickly. “Absorbent materials' are used to mean materials which will absorb water, dyes, and/or solvents so that the resultant paper dries more quickly after ink jet printing than without the absorbent materials. A slow drying sheet will either smudge when removed from the printer or will have poor print quality as the wet inks will undesirably intermingle, reducing print resolution. The addition of water loving and solvent loving cationic polymers gives excellent waterfastness to the sheet, preventing the ink from smudging when exposed to moisture, such as sweat.

Cationic polymers chemically interact with the ink jet inks by forming salt precipitates of the dyes. These precipitates retain the original color of the dye, but prevent the dye from being water soluble. Consequently, the dyes are locked into the coating structure and do not resolubilize when the sheet is moistened. Cationic polymers offer the additional benefit of reducing dot gain, which improves print resolution. The blend of water and solvent loving cationic polymers is important so that the sheet is compatible with both dye and pigment based inks (pigmented inks tend to contain more solvents than dye based inks, thus solvent absorbency is critical). This gives excellent print quality across a wide range of printers and ink sets.

Crosslinkers reduce the water receptivity of the sheet by crosslinking the PVOH, gelatin, and/or polyvinyl pyrrolidone polymer structure, thus allowing less water swellability. By crosslinking the polymer structure to varying degrees, the sheet tackiness is reduced and the print quality can be manipulated by modifying the rate of absorptivity.

Inorganic pigments have a two-fold purpose. First, they offer water absorbency which improves drytime. Second, they can act as an optional matting agent to reduce the gloss of the finished product. Based upon work done by the inventors, aluminas and colloidal silicas are preferred for improving absorbency. Precipitated, fumed or gel silicas are preferred for matting the coating. Optionally plasticizers for example but not limited to polyethylene glycol or glycerin can be incorporated to reduce the brittleness of this coating.

One or more additional ink receptive coatings or ink receptive layers 105 are optional. Additional ink receptive layers are preferable to obtain the highest print quality. An additional ink receptive layer may be comprised of 10-100 dry percent water loving (hydrophilic) polymers such as, but not limited to, polyvinyl alcohol, polyethylene oxide, polyvinyl pyrrolidone, methylcellulose, hydroxyethylcellulose, propylhydroxycellulose, and carboxymethylcellulose; 0. 1-20 dry percent cationic water loving (hydrophilic) and/or solvent loving (lipophilic) polymers such as, but not limited to, polydadmacs, polyethylene imines, polyamides, and polyamines; optionally 0-30 dry percent latex binders such as, but not limited to, styrene-butadiene, polyvinyl acetate, acrylics, vinyl-acetate, ethylene-vinyl chloride, and urethanes; 0.01-20 dry percent crosslinking agents such as, but not limited to, aziradines and chrom alum; 0-10 dry percent plasticizers, and 1-75 dry percent inorganic pigments such as, but not limited to, colloidal, precipitated, fumed, and gel silicas, clay, aluminas, and calcium carbonate; and optionally optical brighteners, dyes, flow agents, and other coating additives. Each additional ink receptive layer can be coated at a coat weight of 1-50 dry gsm on any coater, such as, but not limited to, blade, rod, gate-roll, slot die, cascade, and gravure.

The purpose of the additional ink receptive layer(s) is to provide an ink receptive surface that is not tacky to the touch, as well as to absorb the water and solvents present in the ink so that the sheet dries quickly. A slow drying sheet will either smudge when removed from the printer or will have poor print quality as the wet inks will undesirably intermingle, reducing print resolution. The addition of water loving and solvent loving cationic polymers gives excellent waterfastness to the sheet, preventing the ink from smudging when exposed to moisture, such as sweat. Cationic polymers chemically interact with the ink jet inks by forming salt precipitates of the dyes. These precipitates retain the original color of the dye, but prevent the dye from being water soluble. Consequently, the dyes are locked into the coating structure and do not resolubilize when the sheet is moistened. Cationic polymers offer the additional benefit of reducing dot gain, which improves print resolution. The blend of water (hydrophilic) and solvent loving (lipophilic) cationic polymers is important so that the sheet is compatible with both dye and pigment based inks (pigmented inks tend to contain more solvents than dye based inks so solvent absorbtivity is critical). This gives excellent print quality across a wide range of printers and ink sets. Key components of the additional ink receptive layer(s) are the blend of polyvinyl alcohol; polyethylene oxide; and/or methylcellulose, hydroxyethylcellulose, or propylhydroxycellulose. This blend has been found to give excellent adhesion to pigmented inks so that they will not smudge. These polymer structures may be water swellable, but not too water soluble. When the ink jet ink impacts the coated surface, the polymer structure swells opening up pores. The ink pigments settle in these pores through diffusion and capillary action. The sheet quickly dries and the pores close up, thus trapping the pigments within the polymer structure so they cannot be rubbed off. These components give a sheet that gives good print quality across a wide range of printers and ink sets.

Inorganic pigments have a two-fold purpose. First, the pigments offer water absorbency which improves drytime. Second, the pigments can act as an optional matting agent to reduce the gloss of the finished product. Although this application is not limited by mechanism, the pigments may also offer capillaries for the ink and water molecules to move into the coating structure(s) from the surface, thereby giving a surface that is dry to the touch. Aluminas and colloidal silicas are preferred for improving absorbency. Precipitated, fumed or gel silicas are preferred for matting the coating.

An optional anti-curl layer 106 is applied to the opposite side of the substrate sheet from the undercoating layer, barrier layer and ink receptive coating(s). The anti-curl layer 106 may comprise 1-100 dry percent water loving (hydrophilic) polymers such as, but not limited to, gelatin, polyvinyl alcohol, protein, starch, methylcellulose, hydroxyethylcellulose, propylhydroxycellulose, and carboxymethylcellulose; 1-70 dry percent latex binders such as, but not limited to, styrene-butadiene, poly-vinyl acetate, acrylics, vinyl -acetate, ethylene-vinyl chloride, and urethanes; 0.01-20 dry percent crosslinking agents such as, but not limited, to aziradines, chrom alum, and glyoxals; 1-75 dry percent inorganic pigments such as, but not limited to, colloidal, precipitated, fumed, and gel silicas, clay, alumina, and calcium carbonate; and optionally optical brighteners and dyes. The anti-curl layer may be coated at a coat weight of 1-50 dry gsm on any coater such as, but not limited to, blade, rod, gate-roll, slot die, cascade, and gravure.

The anti-curl layer 106 prevents the sheet from curling both before and after the end use by balancing the water absorbing tendencies of the ink receptive layer(s) 104-105. This keeps the sheet flat so that it won't curl and jam the ink jet printer under high temperature and high humidity conditions. Additionally, it is important to prevent curling in some applications, for example but not limited to photo applications, and for sheets which may be exposed to high humidity ambient conditions in summer or be stored in hot and humid attics.

### EXAMPLE 1

A substrate was prepared by forming on a fourdrinere paper machine a fiber mat consisting of 20% hardwood fibers, 55% softwood fibers, and 25% precipitated calcium carbonate. The substrate was then surface treated with oxidized starch and glycerine to improve surface smoothness and subsequent coating adhesion. The glycerin reduces fiber bonding which improves the dimensional stability (resistance to changes in sheet size due to swelling from moisture absorption/desorption). The sheet included common retention and formation aids; and an ASA hydrophobic surface modifier.

### EXAMPLE 2

A undercoat layer was prepared by coating 15 dry gsm of the following coating on a blade coater using the base sheet from example 1.

| | Dry Parts | |
|---|---|---|
| High Brightness #1 | 72 | Ultra White 90 from |
| Coating Clay | | Engelhard |
| Synthetic Plastic | 10 | Rhopaque HP-543 from |
| Pigment | | Rohm & Haas |
| Polyvinyl acetate | 5 | Vinac 884 from Air Products |
| latex | | |
| Defoamer | 0.09 | Foamblast DF 122 from |
| | | Henkle |
| Thickener | 0.18 | Carboxymethylcellulose 9M8 |
| | | from Hercules |
| Dispersant | 0.05 | Dispex N-40 from Ciba |
| | | Chemicals |
| Flow & leveling | 0.41 | Nopcote C-104 from Geo |
| Agent | | Specialty Chemicals |
| Optical Brightener | 2 | Phorwite P from Bayer |

All parts given in this application are dry parts.

The coated sheet was run through a hot nip super calander to smooth the surface. This sheet gives a high gloss when super calandered and has excellent holdout for the barrier layer coating.

### Example 3

A barrier coat layer was prepared by coating 10 dry gsm of the following coating on a gravure coater using the basesheet from example 2. It was cured using ultra-violet light from a single Fusion H-bulb at a watt density of 300 watts/cm² at a speed of 50 fpm.

| | Dry Parts | |
|---|---|---|
| Aromatic | 15 | CN 131 from Sartomer |
| monoacrylate | | |
| oligomer | | |
| Tris (2- | 105 | SR 368 from Sartomer |
| hydroxylethyl) | | |
| isocyanurate | | |
| triacrylate | | |
| Ethoxylated | 60 | SR 454 from Sartomer |
| trimethylolpropane | | |
| triacrlyate | | |
| Trimethyol propane | 60 | SR 351 from Sartomer |
| triacrylate | | |
| Polyethylene glycol | 18 | SR 259 from Sartomer |
| diacrylate | | |
| Alkoxylated | 18 | SR 9008 from Sartomer |
| trifunctional acrylate | | |
| ester | | |
| Phenyl propanone | 24 | KIP 100F From Sartomer |
| photoinitiator | | |

The above coating had a surface energy of 38 dynes and a gloss of 80% at 60 degrees. The water barrier properties were rated excellent. The surface energy was increased to approximately 46 dynes through corona surface treatment.

### EXAMPLE 4

A barrier coat layer was prepared by coating 10 dry gsm of the following coating on a gravure coater using the base sheet from example 2. It was cured using ultra-violet light from a single Fusion H-bulb at a watt density of 300 watts/cm² at a speed of 50 fpm.

| | Dry Parts | |
|---|---|---|
| Aromatic | 15 | CN 131 from Sartomer |
| monoacrylate | | |
| oligomer | | |
| Tri (2-hydroxylethyl) | 105 | SR 368 from Sartomer |
| isocyanurate | | |
| triacrylate | | |
| Ethoxylated | 60 | SR 454 from Sartomer |
| trimethylolpropane | | |
| triacrlyate | | |
| Polyethylene glycol | 60 | SR 610 from Sartomer |
| diacrylate | | |
| Polyethylene glycol | 39 | SR 344 from Sartomer |
| diacrylate | | |
| Phenyl propanone | 24 | KIP 100F From Sartomer |
| photoinitiator | | |

The above coating had a surface energy of 42 dynes and a gloss of 80% at 60 degrees. The surface energy was increased to approximately 46 dynes through corona surface treatment. The water barrier properties were rated excellent.

### EXAMPLE 5

A barrier coat layer was prepared by coating 27 dry gsm of low density polyethylene on an extrusion coater using the basesheet from example 2. The surface energy was increased to approximately 46 dynes after corona discharge surface treatment.

The barrier surfaces prepared in examples 3, 4, and 5 can be used interchangeably as bases for the following examples.

### EXAMPLE 6

Receptive layer A coat layer was prepared by coating 15 dry gsm of the following coating on a gravure coater using the basesheet sheet from example 4.

| | Dry Parts | |
|---|---|---|
| Polyvinyl alcohol | 76 | Airvol 425 from Air |
| | | Products |
| Polyvinyl | 24 | K-90 from |
| pyrrolidone | | International Specialty |
| | | Products |
| Flow Agent | 0.2 | Triton X-100 from |
| | | Union Carbide |
| Optical Brightener | 1.5 | Phorwite P from |
| | | Bayer |

### EXAMPLE 7

Alternatively, receptive layer A was prepared by coating 15 dry gsm of the following coating on a gravure coater using the basesheet sheet from example 4.

| | Dry Parts | |
|---|---|---|
| Gelatin | 196 | Pork skin, 275 bloom |
| | | from Kind & Knox |
| Acrylic Cationic | 2.3 | Basoplast 250D from |
| Polymer | | BASF |
| Water Loving | 2.3 | Percol 402 from Ciba |
| Cationic | | |
| Polymer | | |
| Flow Agent | 0.13 | Triton X-100 from Union |
| | | Carbide |
| Optical | 0.75 | Phorwite P from Bayer |
| Brightener | | |
| Crosslinker | 0.04 | PFAZ-322 from Sybron |
| pH adjuster | 0.43 | Citric Acid |
| Crosslinker | 0.22 | Chrom Alum |

### EXAMPLE 8

Receptive layer B was prepared by coating 6 dry gsm of the following coating on a gravure coater using the sheet from example 7.

| | Dry Parts | |
|---|---|---|
| Polyvinyl alcohol | 81 | Airvol 540 from Air |
| | | Products |
| Polyvinyl | 19 | K-90 from International |
| pyrrolidone | | Specialty Products |
| Flow Agent | 0.2 | Triton X-100 from Union |
| | | Carbide |
| Water Loving | 5 | Praestol 186KH from |
| (Hydrophilic) | | Stockhausen |
| Cationic Polymer | | |
| Styrene-butadiene | 10 | Dow 679 from Dow |
| latex | | Chemical |
| Optical Brightener | 1.5 | Phorwite P from Bayer |

### EXAMPLE 9

Alternatively, receptive layer B was prepared by coating 6 dry gsm of the following coating on a gravure coater using the sheet from example 7.

| | Dry Parts | |
|---|---|---|
| Polyvinyl alcohol | 81 | Airvol 523 from Air Products |
| Polyvinyl pyrrolidone | 19 | K-90 from International Specialty |
| | | Products |
| Flow Agent | 0.2 | Triton X-100 from Union Carbide |
| Water Loving | 10 | Praestol 186KH from |
| (hydrophilic) Cationic | | Stockhausen |
| Polymer | | |
| Solvent Loving | 3 | Induquat ECR 69/956L from |
| (lipophilic) Cationic | | Indulor |
| Polymer | | |
| Pseudobohemite | 20 | HiQ-40 from Alcoa |
| alumina | | |
| Plasticizer | 10 | Carbowax from Union Carbide |
| Optical Brightener | 1.5 | Phorwite P from Bayer |

Alternatively, receptive layer B was prepared by coating 6 dry gsm of the following coating on a blade coater using the sheet from example 7. Calcium chloride was added as a dye fixative.

| | Dry Parts | |
|---|---|---|
| Polyvinyl alcohol | 11.5 | Airvol 540 from Air Products |
| Hydroxypropylcellulose | 46 | Klucel L from Hercules |
| Acrylic latex | 3 | Versaflex 1 from Hampshire |
| | | Chemical |
| Polyethylene oxide | 13.5 | Polyox WSRN-10 from Union |
| | | Carbide |
| Water Loving | 4 | Praestol 186KH from |
| (hydrophilic) | | Stockhausen |
| Cationic Polymer | | |
| Solvent Loving | 3 | Induquat ECR 69/956L from |
| (lipophilic) | | Indulor |
| Cationic Polymer | | |
| Pseudobohemite | 20 | HiQ-40 from Alcoa |
| alumina | | |
| Surfactant | 0.2 | Zonyl FS-300 from DuPont |
| Calcium Chloride | 2 | |

An anti-curl coating was prepared by coating 12 dry gsm on the backside of example 2 using a blade coater. The barrier and ink receptive coatings were applied at a later time.

| | Dry Parts | |
|---|---|---|
| Calcium | 44 | Hydrocarb 60 from Omya |
| Carbonate | | |
| Protein | 39 | Pro-Coat 200 HV from Protein |
| | | Technologies |
| Precipitated silica | 5.5 | FK 500LS from Degussa |
| Acrylic latex | 6 | Vinac 884 from Air Products |
| Defoamer | 0.04 | Foamblast DF 122 from Henkle |
| Thickener | 0.4 | Carboxymethylcellulose from |
| | | Hercules |
| Dispersant | 0.02 | Dispex N-40 from Ciba |
| | | Chemicals |
| Flow & leveling | 0.21 | Nopcote C-104 from Geo |
| Agent | | Specialty Chemicals |
| Optical | 0.5 | Phorwite P from Bayer |
| Brightener | | |

### EXAMPLE 12

An anti-curl coating was prepared by coating 12 dry gsm on the backside of example 2 using a gravure coater. The barrier and ink receptive coatings were applied at a later time.

| | Dry Parts | |
|---|---|---|
| Gelatin | 56 | Bone, 210 bloom from Kind |
| | | & Knox |
| Gel silica | 42 | Gasil HP-39 from Crosfield |
| Crosslinker | 0.5 | Chrom Alum |
| Flow Agent | 0.1 | Triton X-100 from Union |
| | | Carbide |

What is claimed is:

1. A paper medium based composition comprising
a substrate;
an undercoat layer;
a barrier coating; and
one or more ink receptive coating (s).

2. The composition of claim 1 further comprising:
one or more anticurl layers.

3. The composition in claim 1 wherein the substrate comprises:
one or more fiber;
one or more starch;
one or more inorganic filler;
one or more retention aid;
one or more formation aid;
one or more plasticizer;
one or more slip agent;
one or more dye;
one or more hydrophobic additive;

4. The composition of claim 3 wherein the plasticizer comprises one or more of the group consisting of polyethylene glycol and glycerine.

5. The composition of claim 1 wherein the undercoat layer comprises:
one or more inorganic pigment;
one or more latex;
one or more binder;
one or more flow agent;
one or more slip agent;
one or more dye; and
one or more additive.

6. The composition of claim 1 wherein the barrier coating comprises:
one or more monomer;
one or more oligomer; and
one or more photoinitiators.

7. The composition of claim 6 wherein the monomer comprises one or more of the group consisting of a urethane, an epoxy and an acrylate.

8. The composition of claim 6 wherein the oligomer comprises one or more of the group consisting of a urethane, an epoxy and an acrylate.

9. The composition of claim 6 wherein the monomer is between about 1 and about 100 dry percent of the composition.

10. The composition of claim 6 wherein the oligomer is between about 1 and about 100 dry percent of the composition.

11. The composition of claim 6 wherein the photoinitiator(s) are between about 1 and 20 dry percent of the composition.

12. The composition of claim 1 wherein the barrier coating is treated with:
a corona discharge.

13. The composition of claim 1 wherein the barrier coating is treated with:
flame treatment.

14. The composition of claim 1 wherein the barrier coating is treated with:
subbing coating.

15. The composition of claim 1 comprising one or more ink receptive layer(s) comprising one or more absorbent materials.

16. The composition of claim 1 wherein one or more ink receptive layers is covered by the barrier layer.

17. The composition of claim 1 wherein said ink receptive layer(s) comprises one or more materials selected from the group of hydrophilic polymers consisting of polyvinyl alcohol, gelatin, methylcellulose, hydroxyethylcellulose, propylhydroxycellulose, and polyvinyl pyrrolidone.

18. The composition of claim 1 wherein said ink receptive layer(s) comprise one or more cationic polymer material selected from the group consisting of polydadmacs, polyethylene imines, polyamides, and polyamines.

19. The composition of claim 17 wherein the water loving polymer is between about 10 and about 100 dry percent of the composition.

20. The composition of claim 18 wherein the cationic polymer material is between about 0.1 and about 20 dry percent of the composition.

21. The composition of claim 1 wherein said ink receptive layer(s) comprise one or more latex binders selected from the group consisting of styrene butadiene, polyvinyl acetate, acrylic, vinyl-acetate, ethylene-vinyl chloride, and urethane.

22. The composition of claim 21 wherein the latex binder is between about 0 and about 30 dry percent of the composition.

23. The composition of claim 1 wherein said ink receptive layer(s) comprise one or more cross-linking agent selected from the group consisting of aziradines and chrom alum.

24. The composition of claim 23 wherein the cross-linking agent is between about 0.01 and about 20 dry percent of the composition.

25. The composition of claim 1 wherein said ink receptive layer(s) comprise one or more inorganic pigments selected from the group consisting of colloidal silica, precipitated silica, fumed silica, gel silica, clay, an alumina, and a calcium carbonate.

26. The composition of claim 25 wherein the inorganic pigment is between about 0 and about 75 dry percent of the composition.

27. The composition of claim 1 comprising said ink receptive layer(s) comprise one or more color pigmented and brightener dye.

28. The composition of claim 1 further comprising one or more flow agent.

29. The composition of claim 1 further comprising one or more coating additive.

30. The composition of claim 1 wherein the ink receptive coating is coated at a coat weight of between about 1 and about 50 dry gsm.

31. The composition of claim 1 further comprising a plasticizer.

32. The composition of claim 2 wherein said anti-curl layers applied to a side of the substrate, said side opposite a side on which an undercoat layer is located.

33. The composition of claim 2 wherein the anti-curl layer comprises:
one or more hydrophilic polymer;
one or more crosslinking agent; and
one or more inorganic pigment.

34. The composition of claim 33 wherein the anti-curl layer further comprises one or more latex binders.

35. The composition of claim 33 wherein the water loving polymer comprises one or more of the group consisting of gelatin, polyvinyl alcohol, protein, starch, methylcellulose, hydroxyethylcellulose, propylhydroxycellulose, and carboxymethylcellulose.

36. The composition of claim 33 wherein the water loving polymer is between about 1 and about 100 dry percent of the composition.

37. The composition of claim 34 wherein the latex binder comprises one or more of the group consisting of styrene-butadiene, polyvinyl acetate, acrylic, vinyl-acetate, ethylene-vinyl chloride, and urethane.

38. The composition of claim 34 wherein the latex binder is between about 1 and about 70 dry percent of the composition.

39. The composition of claim 33 wherein the crosslinking agent comprises one or more of the group consisting of aziradine, chrom alum, and glyoxal.

40. The composition of claim 33 wherein the crosslinking agent is between about 0.01 and about 20 dry percent of the composition.

41. The composition of claim 33 wherein the inorganic pigment comprises one or more of the group consisting of colloidal silica, precipitated silica, fumed silica, gel silica, clay, alumina, and calcium carbonate.

42. The composition of claim 33 wherein the inorganic pigment is between about 1 and about 75 dry percent of the composition.

43. The composition of claim 33 wherein the anti-curl layer is coated at a coat weight of between about 1 and about 50 dry gsm.

44. The composition of claim 1 wherein the barrier coating has a surface energy of about 48 to about 55 dynes.

45. The composition of claim 1 wherein the barrier coating has a surface energy of about 30 to about 55 dynes.

46. The composition of claim 1 wherein the barrier coating comprises polyethylene.

47. The composition of claim 1 wherein the barrier coating is cured via one or more of the group consisting of ultraviolet energy, electron beam energy, and thermal energy.

48. The composition of claim 1 wherein the barrier coating is coated at a coat weight between about 1 to about 30 dry gsm.

49. The composition of claim 1 wherein the barrier coating is coated at a coat weight between about 2 to about 9 dry gsm.

50. The composition of claim 1 wherein the ink receptive coating(s) is coated at a coat weight between about 1 to about 22 dry gsm.

51. The composition of claim 32 wherein the anticurl coating is coated at a coat weight of about 3 to about 15 dry gsm.

52. The composition comprising:
a substrate comprising 20% hardwood fibers, about 55% softwood fibers and about 25% precipitated calcium carbonate;
an undercoat layer comprising about 72 parts clay, about 10 parts synthetic plastic pigment, 5 parts polyvinyl acetate latex, about 0.09 parts defoamer, about 0.18 parts carboxymethylcellulose, about 0.05 parts dispersant, about 0.41 parts flow and leveling agent and about 2 parts optical brightener;
a barrier layer comprising about 15 parts aromatic monoacrylate oligomer, about 105 parts tri(2-hydroxylethyl)isocyanurate triacrylate, about 99 parts ethoxylated trimethylolpropane triacrylate and about 24 parts phenyl propanone photoinitiator;
a first ink receptive coating comprising about 196 parts gelatin, about 2.3 parts acrylic cationic polymer, about 2.3 parts water loving cationic polymer, about 0.13 parts flow agent, about 0.75 parts optical brightener, about 0.04 parts crosslinker, about 0.43 parts pH adjuster and about 0.22 parts crosslinker;
a second ink receptive coating comprising about 11.5 parts polyvinyl alcohol, about 46 parts hydroxypropylcellulose, about 3 parts acrylic latex, about 13.5 parts polyethylene oxide, about 4 parts hydrophilic cationic polymer, about 3 parts lipophilic cationic polymer, about 20 parts pseudobohemite alumina, about 0.2 parts surfactant and about 2 parts calcium chloride; and
an anticurl coating comprising about 56 parts gelatin, about 42 parts gel silica, about 0.5 parts chrom alum, and about 0.1 parts flow agent.
